(19) United States
(12) Patent Application Publication
(10) Pub. No.: US 2004/0244763 A1
(43) Pub. Date: Dec. 9, 2004

(54) Internal combustion engine and method for the operation thereof

(76) Inventor: Andreas Martin, Hunstetten (DE)

Correspondence Address: WILLIAM COLLARD, COLLARD & ROE, P.C., 1077 NORTHERN BOULEVARD, ROSLYN, NY, 11576, US

(21) Appl. No.: 10/486,629

(22) PCT Filed: Aug. 9, 2002
(86) PCT No.: PCT/EP02/08947

(30) Foreign Application Priority Data
Aug. 11, 2001 (DE) 101 39 650.3

(51) Int. Cl. F02B 53/04

(52) U.S. Cl. 123/237

(57) ABSTRACT

The combustion engine has two rotary pistons (2,3) mounted rotatable in a housing (4) and each having a cylindrical core and outer ring whose radius corresponds in areas to the inner radius of the housing and whose thickness corresponds in areas to the thickness of the core. In the outer ring is a segment with smaller radius and/or different thickness so that a combustion chamber is defined between each housing and piston and the combustion chambers are connectable together. They can be sealed from each other at least in areas through at least one slider (5,6) which can be moved by the rotary piston.

The invention relates to an internal combustion engine having rotary pistons that are mounted to rotate in a housing, as well as to a method for operating such an internal combustion engine. In this connection, fuel is drawn or injected into a combustion space that is formed between the housing and a rotary piston. Compression and combustion of the fuel also take place in this combustion space.

Rotary piston engines or circular piston engines have the advantages, as compared with lifting piston engines, that in total, fewer parts are required, the masses that move back and forth are reduced, no valve drive has to be provided, and the construction size and the weight are less.

It is the task of the invention to create such an internal combustion engine that is cost-advantageous in operation and in production, as well as to propose a reliable method for operating such an engine.

According to the invention, this task is accomplished essentially by means of an internal combustion engine having at least two rotary pistons that are mounted to rotate in a housing, whereby the rotary pistons each have a cylindrical core and an outer ring, the radius of which corresponds, in some regions, to the inside radius of the housing, and the thickness of which corresponds, in some regions, to the thickness of the cylindrical core, whereby at least one segment having a lesser radius and/or a different thickness as compared with the thickness of the core is provided in the outer ring, so that a combustion space is defined between the housing and the rotary piston, in each instance, whereby the combustion spaces can be connected with one another and sealed off from one another, at least in some regions, by way of at least one slide that can be moved independently of the rotary pistons. In this manner, compressed fuel can be transferred to the combustion space defined by a first rotary piston, into a combustion space defined by a second rotary piston. At the same time, the combustion spaces are divided into two regions having a changeable size, in each instance, by means of at least one slide. In this manner, it is possible that when fuel is combusted in one region of the combustion space, fuel is compressed in the other region of the combustion space, at the same time.

Preferably, at least two rotary pistons are coupled with one another, with regard to their rotation, by way of a synchronization device. In this manner, the movements of the rotary pistons as well as of the slides are precisely coordinated with one another, so that misfiring or other disruptions in operation are avoided.

According to an embodiment of the invention, the rotary pistons are mounted coaxially on a common shaft. The arrangement of the rotary pistons behind one another on a common shaft allows a particularly space-saving method of construction of the internal combustion engine. Preferably, four, six, eight or more rotary pistons are mounted coaxially with regard to one another, on a shaft. By means of the arrangement of four or eight rotary pistons, particularly quiet running can be assured, since the slides move towards one another, in each instance. In this way, the stresses that occur in the engine are reduced, and consequently, a lower tendency to break down is achieved.

In this embodiment, two adjacent rotary pistons preferably rotate in opposite directions during operation. This makes it possible for fuel to alternately be compressed and combusted in one combustion space, while fuel is drawn or injected in the other combustion space, and waste gases are expelled. Because of the synchronization and coupling of the rotary pistons among one another, during the combustion of fuel in one of the combustion spaces, the other rotary piston, in the combustion space of which fuel is being drawn or injected in, while waste gas is being expelled, at the same time, is also being driven, at the same time. In the case of an internal combustion engine having four coaxially arranged rotary pistons, the two outer rotary pistons preferably rotate in one direction, while the two inner rotary pistons synchronously rotate in the opposite direction.

According to another embodiment of the invention, it is provided that the rotary pistons are mounted on at least two shafts arranged parallel to one another. In this embodiment, as well, it is possible to divide the combustion spaces into different regions, by means of radially movable slides.

According to a third embodiment of the invention, the rotary pistons are mounted partly on shafts that are coaxial to one another and partly on shafts that are parallel to one another. By means of an arrangement of four rotary pistons, it is possible, in this way, to produce extremely quiet running of the internal combustion engine. In this way, the stresses that occur in the engine are reduced, and consequently, a lower tendency to break down is achieved.

In a further development of the invention, it is provided that the slides are mounted in the housing. In this way, mounting the slides can be carried out using simple means. In addition, however, the slides can also be mounted on the shaft and/or on the rotary piston.

Furthermore, it can be provided, according to the invention, that the outer ring of the rotary piston has two transition segments, which connect a segment having a lesser radius and/or a lesser thickness with a segment having a greater radius and/or a greater thickness. In this manner, the slides can be guided along the segments of the rotary pistons, so that a separate control of the slides can be eliminated.

The thickness of the core of the rotary piston can correspond to the thickness of the segment of the outer ring whose radius corresponds to the inside radius of the housing. As an alternative to this, the thickness of the inner core of the rotary piston corresponds to the thickness of the segment of the outer ring having a reduced thickness. This achieves the result that the slides can be dual-mounted in the housing, namely both relative to the shaft and relative to the housing edge. In this manner, the moments that act in the case of one-sided mounting of the slides are clearly reduced.

In the case of a method according to the invention for operating an internal combustion engine, it is provided that two rotary pistons, in each instance, are synchronized relative to one another, with regard to their rotation, that the fuel compressed in a first combustion space, which is formed by a first rotary piston, is guided into a second combustion space, which is formed by a second rotary piston, and combusted there. In this manner, it is possible that the cycles of intake or injection of the fuel, compression, combustion, and expulsion are carried out at every rotation of the rotary pistons. This also eliminates valves for controlling the fuel feed and for discharge of the waste gases.

Preferably, compression of the fuel and combustion of fuel that has already been compressed takes place at the same time, in two regions of a combustion space formed between a rotary piston and the housing, whereby the regions are separated from one another by means of a slide. The energy that is released during combustion of the fuel is thereby used directly for compressing new fuel. Energy losses resulting from the transfer of the energy released during combustion are avoided in this manner. Consequently, the method can be carried out with low fuel consumption.

Furthermore, it can be provided, according to the invention, that drawing or injecting in the fuel and expelling the waste gases takes place simultaneously in two regions of a combustion space formed between a rotary piston and the housing, whereby the regions are separated from one another by means of a slide. The rotation of the rotary piston causes the region of the combustion chamber to be filled with fuel to increase so that the aspiration of fuel is facilitated while the region of the combustion space containing the waste gas to be expelled simultaneously decreases, and thereby the waste gas is completely discharged from the combustion space.

Finally, it can be provided, according to the invention, that compression of the fuel and combustion of fuel that has already been compressed takes place in a combustion space formed by a first rotary piston, at the same time with drawing or injecting in fuel, and expelling waste gas, in a combustion space formed by a second rotary piston. A pair of rotary pistons connected with one another thereby performs drawing or injecting in fuel, compressing the fuel, combusting fuel, as well as expelling the waste gases, all at the same time.

Two embodiments of the invention will be explained in greater detail below, making reference to the drawing.

This shows:

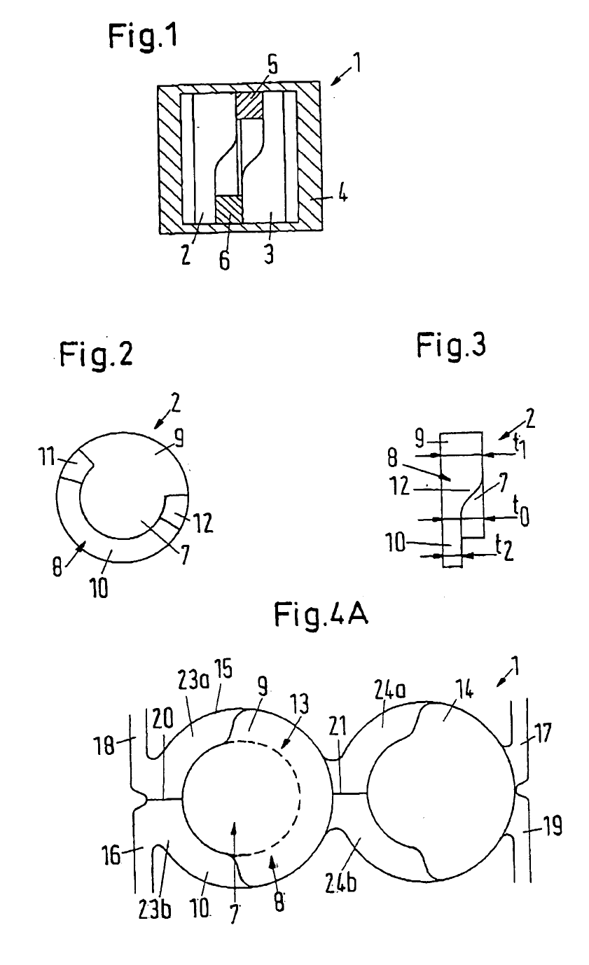

FIG. 1 a schematic view of a section through an internal combustion engine according to a first embodiment;

FIG. 2 a side view of a rotary piston from FIG. 1;

FIG. 3 a top view of the rotary piston according to FIG. 2;

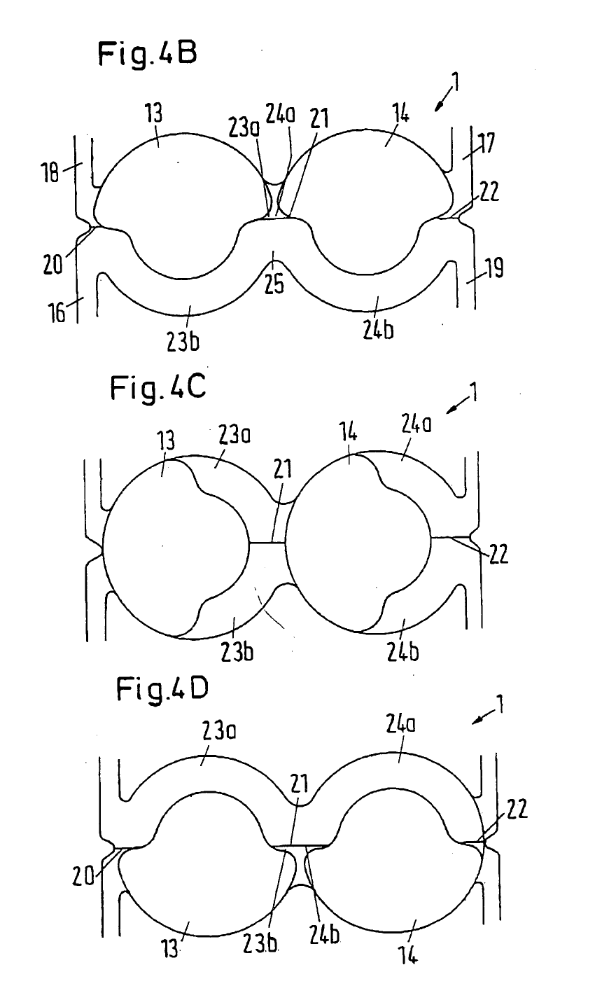

FIG. 4a-4d a schematic view of a section through an internal combustion engine according to a second embodiment, in different working states.

The internal combustion engine 1 shown in FIG. 1 has two coaxially mounted rotary pistons 2 and 3. The rotary pistons 2 and 3 are accommodated in a cylindrical housing 4. Two slides 5 and 6 are provided between the rotary pistons 2 and 3, which slides are mounted so as to move in the housing 4.

As is particularly evident in FIG. 2 and 3, the rotary pistons 2 and 3, which have the same shape, have a cylindrical core 7 having the same thickness t0 over the circumference. This core 7 is connected in one piece with an outer ring 8, which has a thickness that varies over the circumference. In this connection, the outer ring 8 has a first segment 9, the thickness t1 of which corresponds to the thickness t0 of the core 7. A second segment 10 has a lesser thickness t2 than the core 7 and is connected with the first segment 9 by means of a slanted transition segment 11 and 12, in each instance.

The rotary pistons 2 and 3 are arranged in the housing 4 in such a manner that the slides 5 and 6, respectively, are displaced by the rotary pistons 2 and 3 in an axial direction when the latter rotate. In this connection, the slides 5 and 6 glide on the outer ring 8 of the rotary pistons 2 and 3. In this manner, the rotary pistons 2 and 3 define two combustion spaces between themselves, which spaces are formed by the lesser thickness t2 of the second ring segment 10. Each of these combustion spaces is divided into two regions having a changeable size, by means of one of the slides 5 and 6, respectively.

By means of the rotation of the rotary pistons 2 and 3 in opposite directions, a first combustion space along the slides 5 and 6, respectively, increases in size to the same extent that the second combustion space region becomes smaller. At the same time, the combustion spaces are connected with one another in certain positions of the rotary pistons 2 and 3 relative to one another.

In a further embodiment, not shown, the thickness t0 of the inner core 7 of the rotary piston corresponds to the thickness t2 of the segment 10 of the outer ring 8. This achieves the result that the slides 5 and 6 can be dual-mounted in the housing, namely both relative to the shaft and relative to the housing edge. In this manner, the moments that act in the case of one-sided mounting of the slides 5 and 6 are clearly reduced.

The functional principle of an internal combustion engine 1 will be explained using a second embodiment, making reference to FIG. 4a to 4d. In this connection, the internal combustion engine 1 according to the second embodiment corresponds essentially to the internal combustion engine according to the first embodiment shown in FIG. 1 to 3, whereby the rotary pistons 13 and 14 are not arranged coaxially behind one another, but rather lie on parallel axes next to one another. Furthermore, the rotary pistons 13, 14 have an outer ring 8 about the core 7, the radius of which is different in different segments. In a first segment 9, the radius of the ring 8 corresponds to the inside radius of the housing 15, while the radius of a second segment 10 is smaller than the inside radius of the housing 15. Transition segments 11 and 12 between the first and second segment 9 and 10, respectively, have a radius that changes gradually over the circumference.

In the housing 15, which is shown schematically, a fuel inlet 16 and 17, respectively, is provided for each rotary piston 13, 14, as is an outlet opening 18 and 19, respectively. Three slides 20, 21, and 22 are mounted in the housing 15, in such a manner that they can be displaced in the radial direction by means of the rotary pistons 13 and 14. A combustion chamber 23 and 24 is defined between the housing 15 and the rotary pistons 13 and 14, respectively, which chamber is divided into two regions 23a and 23b, i.e. 24a and 24b, which can change in size, by means of the slices 20, 21, and 22, as a function of the angle position of the rotary pistons 13 and 14 relative to one another.

The rotary pistons 13, 14 close off the fuel inlet 16 or 17, respectively, and/or the outlet opening 18 or 19, respectively, with their first segments 9 having a large radius, in certain angle positions. At the same time, the second segments 10 of the rotary pistons 13, 14, which have a smaller radius, allow flow of fuel into the combustion space, in each instance, or expulsion of waste gases. Valve control can therefore be eliminated.

In the position of the rotary pistons 13 and 14 shown in FIG. 4a, a fuel mixture is drawn or injected into the region 23b of the combustion space 23 by way of the inlet 16. Combustion waste gases are expelled from the region 23a of the combustion space 23 by way of the outlet opening 18. A fuel mixture that was drawn or injected in by way of the inlet 17 is compressed in the region 24a of the combustion space 24. A fuel mixture is combusted in the region 24b of the combustion space 24, as a result of which the rotary piston 14 is driven counterclockwise. By way of a synchronization device, not shown, the rotary pistons 13 and 14 are connected with one another in such a manner that the rotary piston 13 is also driven counterclockwise in the figures, jointly with the rotary piston 14.

In FIG. 4b, the working cycle of the rotary piston 14 has been completed and the combustion waste gases are expelled through the opening 19. The intake process in the combustion space 23 of the rotary piston 13 is also almost completely finished. In this connection, the combustion spaces 23 and 24 are connected with one another along a connection channel 25 in the housing 15. The fuel that was previously compressed in the region 24a is passed into the newly opening region 23a by way of the slide 21. The compressed fuel mixture can then be ignited, so that the rotary piston 13 is moved counterclockwise. In this connection, the regions 23a and 23b are separated from one another by means of the slide 21, so that the fuel mixture drawn in is not ignited in the region 23b.

In the position of the rotary pistons 13 and 14 shown in FIG. 4c, the ignited fuel mixture combusts in the region 23a, in order to activate the rotary piston 13. As a result of the enlargement of the region 23a, the size of the region 23b decreases, at the same time, so that the fuel mixture located in it is compressed. While combustion waste gases are expelled from the region 24b, new fuel is drawn or injected in, in the region 24a.

In FIG. 4d, the fuel compressed in the region 23b is guided into the region 24b, in which it is subsequently ignited. At the same time, combustion waste gases are expelled from the region 23a, and the region 24a is completely filled with new fuel. With this, a cycle of the internal combustion engine, comprising a complete rotation of each rotary piston, has been completed, whereby the four work steps of drawing or injecting in fuel, compressing the fuel, combusting the fuel, and expelling the waste gases, are carried out, in each instance, in the combustion spaces 23 and 24 formed by the rotary pistons 13 and 14.

### Reference Symbol List

1 internal combustion engine

2 rotary piston

3 rotary piston

4 housing

5 slide

6 slide

7 cylindrical core

8 outer ring

9 first segment

10 second segment

11 transition segment

12 transition segment

13 rotary piston

14 rotary piston

15 housing

16 inlet opening

17 inlet opening

18 outlet opening

19 outlet opening

20 slide

21 slide

22 slide

23 combustion space

24 combustion space

25 connection channel

t0 thickness of the core 7

t1 thickness of the first segment 9

t2 thickness of the second segment 10

1-14. (canceled)

15. Internal combustion engine having at least two rotary pistons (2, 3; 13, 14) that are mounted to rotate in a housing (4, 15), whereby the rotary pistons (2, 3, 13, 14) each have a cylindrical core (7) and an outer ring (8), the radius of which corresponds, in some regions, to the inside radius of the housing (4, 15), and the thickness (t1, t2) of which corresponds, in some regions, to the thickness (t0) of the cylindrical core (7), whereby at least one segment (10) having a lesser radius and/or a different thickness (t1, t2) as compared with the thickness (t0) of the core (7) is provided in the outer ring (8), so that a combustion space (23, 24) is defined between the housing (4, 15) and the rotary piston (2, 3, 13, 14), in each instance, whereby the combustion spaces (23, 24) can be connected with one another, characterized in that at least two adjacent rotary pistons (2, 3), which are mounted coaxially on a common shaft, are coupled with one another by way of a synchronization device, in such a manner that they rotate in opposite directions during operation, and that the combustion spaces (23, 24) can be sealed off from one another, at least in some regions, by way of at least one slide (5, 6, 20, 21, 22) that can be moved independently of the rotary pistons (2, 3, 13, 14).

16. Internal combustion engine having at least two rotary pistons (2, 3; 13, 14) that are mounted to rotate in a housing (4, 15), whereby the rotary pistons (2, 3, 13, 14) each have a cylindrical core (7) and an outer ring (8), the radius of which corresponds, in some regions, to the inside radius of the housing (4, 15), and the thickness (t1, t2) of which corresponds, in some regions, to the thickness (t0) of the cylindrical core (7), whereby at least one segment (10) having a lesser radius and/or a different thickness (t1, t2) as compared with the thickness (t0) of the core (7) is provided in the outer ring (8), so that a combustion space (23, 24) is defined between the housing (4, 15) and the rotary piston (2, 3, 13, 14), in each instance, whereby the combustion spaces (23, 24) can be connected with one another, characterized in that at least two adjacent rotary pistons (13, 14), which are mounted on shafts that are parallel to one another, are coupled with one another by way of a synchronization device, in such a manner that they rotate in the same direction during operation, and that the combustion spaces (23, 24) can be sealed off from one another, at least in some regions, by way of at least one slide (5, 6, 20, 21, 22) that can be moved independently of the rotary pistons (2, 3, 13, 14).

17. Internal combustion engine according to claim 15, wherein the rotary pistons (2, 3) are mounted coaxially on a common shaft.

18. Internal combustion engine according to claim 17, wherein two adjacent rotary pistons (2, 3) rotate in opposite directions in operation.

19. Internal combustion engine according to claim 15, wherein the rotary pistons (13, 14) are mounted on two shafts that are parallel to one another.

20. Internal combustion engine according to claim 15, wherein the rotary pistons (2, 3, 13, 14) are mounted partly on shafts that are coaxial to one another and partly on shafts that are parallel to one another.

21. Internal combustion engine according to claim 15, wherein the slides (5, 6, 20, 21, 22) are mounted in the housing (4, 15).

22. Method for operating an engine according to claim 15, whereby a fuel is drawn or injected into a combustion space (23, 24), compressed there and expelled after combustion, wherein two rotary pistons (2, 3, 13, 14), in each instance, are synchronized relative to one another, with regard to their rotation, in such a manner that at least two adjacent rotary pistons (2, 3), which are mounted coaxially on a common shaft, rotate in opposite directions during operation, and/or that at least two adjacent rotary pistons (13, 14), which are mounted on shafts that are parallel to one another, rotate in the same direction during operation, whereby the fuel compressed in a first combustion space (23, 24), which is formed by a first rotary piston (2, 3, 13, 14), is guided into a second combustion space (24, 23), which is formed by the second rotary piston (3, 2, 14, 13), and combusted there.

23. Internal combustion engine according to claim 15, wherein the thickness (t0) of the core (7) of the rotary pistons (2, 3) corresponds to the thickness (t1) of the segment (9) of the outer ring (8).

24. Internal combustion engine according to one of claims 1 to 8, characterized in that the thickness (t0) of the core (7) of the rotary pistons (2, 3) corresponds to the thickness (t2) of the segment (10) of the outer ring (8).

25. Method for operating an engine according to claim 15, whereby a fuel is drawn or injected into a combustion space (23, 24), compressed there and expelled after combustion, characterized in that two rotary pistons (2, 3, 13, 14), in each instance, are synchronized relative to one another, with regard to their rotation, that the fuel compressed in a first combustion space (23, 24), which is formed by a first rotary piston (2, 3, 13, 14), is guided into a second combustion space (24, 23), which is formed by the second rotary piston (3, 2, 14, 13), and combusted there.

26. Method according to claim 25, wherein compression of the fuel and combustion of fuel that has already been compressed takes place at the same time, in two regions (23a, 23b, 24a, 24b) of a combustion space (23, 24) formed between a rotary piston (2, 3; 13, 14) and the housing (4, 15), which regions are separated from one another by means of a slide (5, 6, 20, 21, 22).

27. Method according to claim 25, wherein drawing or injecting in the fuel and expelling the waste gases takes place simultaneously in two regions (23a, 23b, 24a, 24b) of a combustion space (23, 24) formed between a rotary piston (2, 3, 13, 14) and the housing (4, 15), which regions are separated from one another by means of a slide (5, 6, 20, 21, 22).

28. Method according to claim 26, wherein compression of the fuel and combustion of fuel that has already been compressed takes place in a combustion space (23, 24) formed by a first rotary piston (2, 3, 13, 14), at the same time with drawing or injecting in fuel, and expelling waste gases, in a combustion space (24, 23) formed by a second rotary piston (3, 2, 14, 13).
